(19) United States
(12) Patent Application Publication
(10) Pub. No.: US 2018/0181038 A1
(43) Pub. Date: Jun. 28, 2018

(54) FIXATION MEMBER

(71) Applicant: SYNZTEC CO., LTD., Tokyo (JP)

(72) Inventors: Wataru NEMOTO, Kanagawa (JP); Tadashi HASEGAWA, Kanagawa (JP)

(21) Appl. No.: 15/841,658

(22) Filed: Dec. 14, 2017

(30) Foreign Application Priority Data
Dec. 27, 2016 (JP) 2016-254154

(51) Int. Cl. G03G 15/20; F16C 13/00; B32B 15/04

(52) U.S. Cl. CPC G03G 15/2057; G03G 15/206; G03G 15/2089; G03G 2215/2032; B32B 15/043; G03G 2215/2022; G03G 2215/2009; F16C 13/006

(57) ABSTRACT

An object of the invention is to provide a fixation member which has an unfixed toner fixation function and ensures high releasability, low chargeability, and high friction. The fixation member has an elastic layer, and a release layer on the external surface of the elastic layer, wherein the release layer is formed of a fluororesin tube having low chargeability and a percent dielectric relaxation of 15% or higher.

The entire disclosure of Japanese Patent Application No. 2016-254154 filed on Dec. 27, 2016 is expressly incorporated by reference herein.

### BACKGROUND OF THE INVENTION

### Field of the Invention

The present invention relates to an image-fixing member (hereinafter referred to as a “fixation member”) which is employed in a fixation unit of an image-forming apparatus such as an electrophotographic printer or copying machine.

### Background Art

Generally, an image-fixation unit of an image-forming apparatus such as an electrophotographic printer or copying machine employs a fixation belt formed of an electrocast layer (nickel (Ni), Ni/copper (Cu)/Ni, PI (polyimide resin), SUS (stainless steel), etc.), an elastic layer, a release layer (fluororesin tube), etc.; a fixation roller or a pressure roller formed of a core body (e.g., a metallic core), an elastic layer, a release layer, etc.; or the like.

In a typical fixation apparatus, a fixation belt (a fixation member in the form of a belt) rotates with a pressure roller in rotation and is heated by means of heating means disposed in a space. An unfixed toner image on a recording medium (e.g., a paper sheet) is fixed through heat and pressure during passage of the recording medium between the fixation belt and the pressure roller.

In such a fixation apparatus, the fixation belt faces the surface of the recording medium to which surface an unfixed toner is jetted, and the fixation belt comes into direct contact with the unfixed toner. The pressure roller faces the surface of the recording medium opposite the toner-deposited surface. A nip portion is provided between the pressure roller and the fixation belt. In an alternative mode of the fixation apparatus, the fixation belt is disposed so as to face the surface of the recording medium opposite the toner-deposited surface and also serves as a pressure roller (i.e., a pressure belt type).

The pressure roller of a fixation apparatus is required to possess three characteristics in addition to the unfixed toner fixation function. That is, firstly, the pressure roller desirably has high releasability, which lowers surface energy so as to reduce the amount of toner or paper dust, to thereby prevent staining of the back surface of the recording medium. Secondly, the pressure roller desirably has low chargeability, which reduces the amount of electrically deposited matter, to thereby prevent undesired variation in the developed image. Thirdly, the pressure roller desirably provides high friction. When the roller has high coefficient of friction (hereinafter referred to as “friction coefficient”), the fixation belt can be driven with enhanced gripping performance.

Conventionally, the release layer of a pressure roller is made of a fluororesin such as PFA (perfluoroalkoxyfluororesin) or PTFE (polytetrafluoroethylene), in order to attain high releasability. When a flat surface of the release layer is formed, good contact with a fixation member such as a fixation belt can be attained, whereby sufficient gripping performance for smoothly driving the fixation member can be obtained. However, the amount of electrically deposited matter problematically increases, conceivably due to the insulation property of the surface of the release layer.

In order to solve the above problem, there was previously proposed a pressure roller having a tube-form release layer formed of a fluororesin containing conductive particles (e.g., carbon particles and metal particles) (see, for example, Patent Documents 1 and 2). The amount of electrically deposited matter decreases, conceivably due to the conductive property of the surface of the release layer. However, the surface roughness of the release layer increases due to conductive particles contained therein, and the friction coefficient of the layer decreases. As a result, high gripping performance fails to be attained, which is problematic.

Patent Document 1: Japanese Patent Application Laid-Open (kokai) No. 2014-112201

### Patent Document 2: Japanese Patent No. 4790002

Even when a fluororesin tube having electrical conductivity or insulation property is employed as a release layer, difficulty is encountered in reducing the amount of electrically deposited matter, while high friction coefficient is maintained. In other words, the pressure roller of a fixation apparatus is required to have an unfixed toner fixation function and ensure high releasability, low chargeability, and high friction. However, no such pressure roller has been realized.

### SUMMARY OF THE INVENTION

The present invention has been conceived in order to solve aforementioned problems involved in conventional techniques. Thus, an object of the invention is to provide a fixation member which has an unfixed toner fixation function and ensures high releasability, low chargeability, and high friction.

In a first mode of the present invention for attaining the object, there is provided a fixation member having an elastic layer, and a release layer on the external surface of the elastic layer, wherein the release layer is formed of a fluororesin tube having low chargeability and a percent dielectric relaxation of 15% or higher.

A second mode of the present invention is a specific embodiment of the fixation member of the first mode, wherein the release layer has an arithmetic average roughness (Ra) of 0.02 μm to 0.07 μm.

A third mode of the present invention is a specific embodiment of the fixation member of the first or second mode, wherein the release layer has a friction coefficient of 0.5 or higher.

According to the present invention, there can be provided a fixation member which has an unfixed toner fixation function and ensures high releasability, low chargeability, and high friction.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1 is a cross-section (along the peripheral direction) of an example of the structure of the fixation member according to Embodiment 1;

FIG. 2 is a cross-section (along the axial direction) of an example of the structure of the fixation member according to Embodiment 1;

FIG. 3 is a schematic cross-section of an example of the structure of the fixation apparatus according to Embodiment 2;

FIG. 4 is a schematic cross-section of an example of the structure of the fixation apparatus according to Embodiment 3;

FIG. 5 is a schematic cross-section of an example of the structure of the fixation apparatus according to Embodiment 4; and

FIG. 6 is a sketch showing the test method employed in Test Example 7.

### DETAILED DESCRIPTION OF PREFERRED EMBODIMENTS

Specific embodiment of the present invention will next be described in detail with reference to drawings. Such embodiments are given for the purpose of illustration, and the present invention may be arbitrarily modified, so long as the modification falls within the scope of the present invention. In each drawing, constituent elements; i.e., the shape and dimensions of each member, the thickness of each layer, relative positional relationship, etc. may be drawn in an exaggerated manner, for the purpose of illustrating the present invention. Furthermore, the preposition “on” in the description does not refer limitedly to “directly on.” For example, expressions such as “an elastic layer on the core” and “a release layer on the elastic layer” do not exclude the cases in which another element intervenes between the core and the elastic layer or between the elastic layer and the release layer.

### Embodiment 1

### Pressure Roller

The fixation member according to Embodiment 1 is suitably employed in a fixation unit (or a fixation apparatus) of an image-forming apparatus such as an electrophotographic copying machine or printer. The fixation member can fix an unfixed toner image onto a recording medium (e.g., a paper sheet) through heat and pressure. In Embodiment 1, a pressure roller is exemplified as a fixation member.

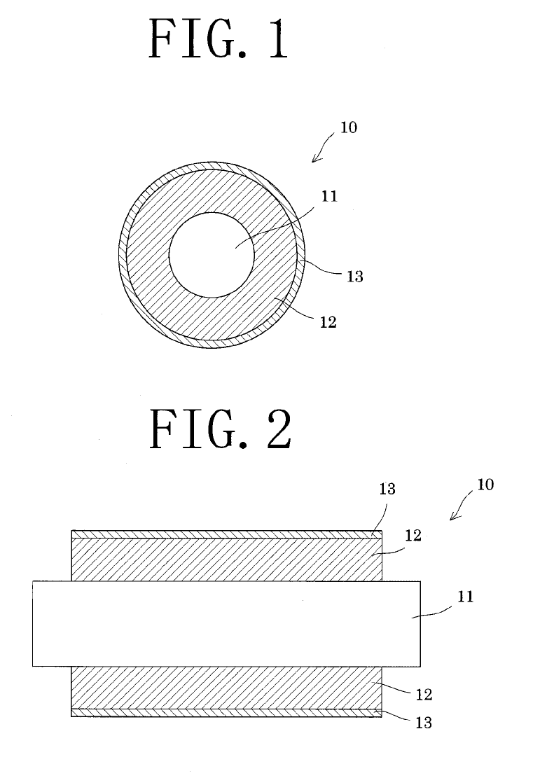

FIG. 1 is a cross-section, along the peripheral direction, of an example of the structure of the fixation member according to Embodiment 1. FIG. 2 is a cross-section, along the axial direction, of an example of the structure of the fixation member according to Embodiment 1. As shown in the drawings, the pressure roller 10 serving as a fixation member includes a core 11, an elastic layer 12 formed on the core 11, and a release layer 13 formed on the elastic layer 12. On the core 11, the elastic layer 12 and the release layer 13 are sequentially stacked. Notably, if needed, the pressure roller 10 may be provided with one or more additional layers under the elastic layer 12.

The core 11 is made of a metallic or resin material which has excellent thermal conductivity and mechanical strength. No particular limitation is imposed on the material of the core 11, and metallic materials such as SUS alloy, nickel (Ni), nickel alloy, iron (Fe), magnetic stainless steel, cobalt-nickel (Co—Ni) alloy, and resin materials such as polyimide (PI) resin may be used. Also, no particular limitation is imposed on the shape of the core 11. The core 11 may be hollow or non-hollow.

On the external surface of the core 11, the elastic layer 12 is provided by the mediation of an adhesive layer (not illustrated). The elastic layer 12 may be formed of a known elastic material such as silicone rubber, fluororubber, or urethane rubber. Among these elastic materials, any silicone rubber may be used with no limit, so long as the silicone rubber forms an elastic body through thermal curing. Specific examples thereof include liquid silicone rubber and millable silicone rubber. Of these, liquid silicone rubber is preferred. Commercial silicone rubber products may also be used. Needless to say, two or more silicon rubbers may be used in combination.

The elastic layer 12 may have an electrically insulating property or electrical conductivity. In the case where conductivity is imparted to the elastic layer 12, conductive particles of carbon, metal, or the like, or an ion conducting agent may be added to the aforementioned elastic material. If needed, one or more conductive particle species or ion conducting agents may be added.

No particular limitation is imposed on the form of carbon added to the elastic material, so long as the carbon species can impart electrical conductivity to the elastic layer 12. Examples of the carbon species include carbon powder, carbon fiber, carbon thread, carbon needle, and carbon rod. Specific examples include carbon black, carbon fiber, carbon atom cluster, and a mixture thereof. Examples of the carbon fiber include acrylic carbon fiber (PAN), pitch-based carbon fiber (PITCH), carbon fiber-reinforced plastics (FRP), and a mixture thereof. Examples of the carbon atom cluster include carbon nanotubes or the like, and a mixture thereof.

Examples of the metal include nickel (Ni), copper (Cu), phosphorus (P), cobalt (Co), iron (Fe), manganese (Mn), gold (Au), alloys thereof, and oxides thereof. Examples of the form of the metal include powder, fiber, thread, needle, and rod. Alternatively, the aforementioned metallic material may be applied to an inorganic filler such as silica.

Examples of the ion conducting agent include an organic salt, an inorganic salt, a metal complex, and an ionic liquid. Examples of the organic salt include sodium trifluoroacetate. Examples of the inorganic salt include lithium perchlorate. Examples of the metal complex include ferric halide-ethylene glycol, specifically those disclosed in Japanese Patent No. 3655364. Meanwhile, ionic liquid is defined as a molten salt which is liquid at room temperature and is also called “ambient-temperature molten salt.” The melting point of the ionic liquid is 70° C. or lower, preferably 30° C. or lower. Specific examples include those disclosed in Japanese Patent Application Laid-Open (kokai) No. 2003-202722.

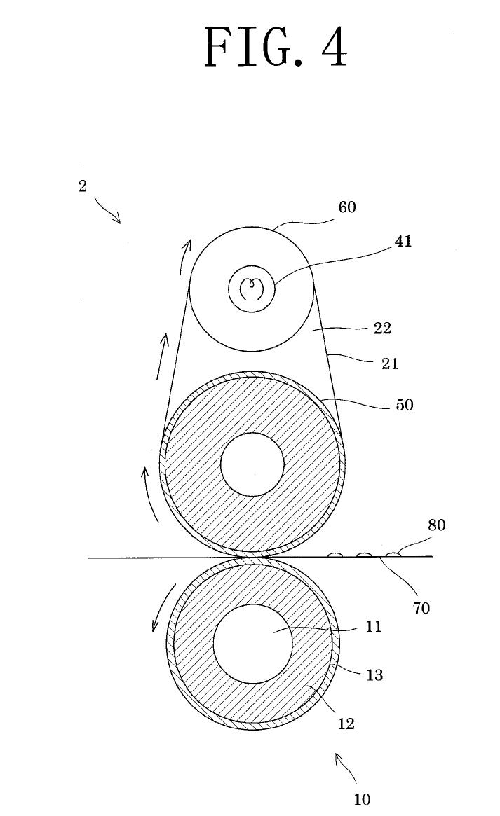

The thickness of the elastic layer 12 is preferably 100 μm or greater, whereby there can be prevented unevenness in gloss, which would otherwise occur in the case where the heated surface of the pressure roller 10 cannot follow irregularities of a recording medium 70 (see FIG. 4) or those of a toner layer, during printing of images. When the thickness of the elastic layer 12 is smaller than 100 μm, difficulty is encountered in attaining the function of the elastic layer 12 as an elastic member. In this case, uniform pressure distribution fails to be attained during fixation of the unfixed toner image 80 (see FIG. 4). As a result, particularly when a full-color image is fixed, the secondary color unfixed toner image 80 cannot be thermally fixed to a satisfactory extent, whereby unevenness is provided in gloss of the fixed images. Color mixing becomes poor due to insufficient melting conditions of the unfixed toner image 80, thereby failing to obtain ultrafine full-color image, which is not preferred.

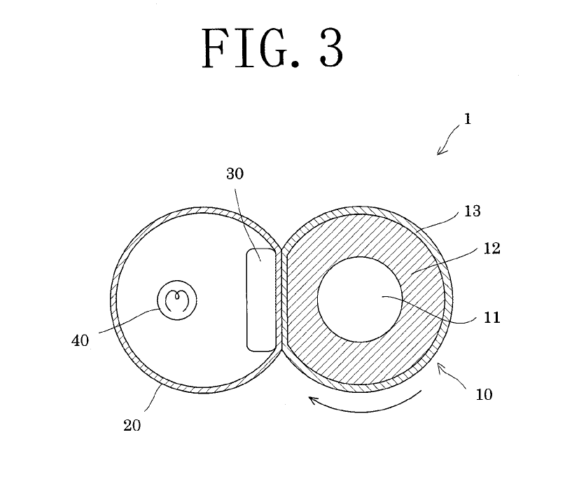

Through provision of the elastic layer 12, the pressure roller 10 can exhibit enhanced flexibility, and heat efficiency to the fixation apparatus 1 employing the roller (see FIG. 3) and the like can be enhanced. As a result, fixability of the unfixed toner image 80 onto the recording medium 70 can be enhanced, to thereby obtain high-quality images. Notably, provision of the elastic layer 12 is optional, and two or more elastic layers may be provided.

In Embodiment 1, the release layer 13 is formed of a synthetic resin material ensuring high releasability, low chargeability, and high friction. An example of such synthetic resin materials is a fluororesin composition containing a fluororesin, a vinylidene fluoride copolymer, and an ionic additive. By use of the resin composition, chargeability of the release layer can be reduced, with excellent electric insulation being maintained. In addition, even when the release layer has been charged through corona discharge, friction, etc., electric charges can immediately be removed.

Examples of the fluororesin which can be incorporated into the fluororesin composition include tetrafluoroethylene-fluoroalkyl vinyl ether copolymer (PFA), tetrafluoroethylene-hexafluoropropylene copolymer (FEP), ethylene-tetrafluoroethylene copolymer (ETFE), polychlorotrifluoroethylene (PCTFE), ethylene-chlorotrifluoroethylene copolymer (ECTFE), and polyvinylidene difluoride (PVDF). These fluororesins may be used singly or in combination of two or more species.

Examples of the ionic additive which can be incorporated into the fluororesin composition include 1-ethyl-3-methylimidazolium bis(trifluoromethylsulfonyl)imide (EMI-TFSI), 1-ethyl-3-methylimidazolium bis(perfluorobutylsulfonyl)imide (EMI-PFBSI), 1-butyl-3-methylimidazolium bis(trifluoromethylsulfonyl)imide, 1-hexyl-3-methylimidazolium bis(trifluoromethylsulfonyl)imide, 1-ethyl-3-methylimidazolium perfluorobutylsulfonate, 1-ethyl-3-methylimidazolium perfluoroethylsulfonate, 1-ethyl-3-methylimidazolium cyclohexafluoropropane-1,3-bis(sulfonyl)imide. These ionic additives may be used singly or in combination of two or more species.

The amount of the ionic additive with respect to the entire amount of the fluororesin composition is preferably 0.01 mass % to 1.0 mass %. When the ionic additive amount is smaller than 0.01 mass %, chargeability does not decrease, whereas when the ionic additive amount is in excess of 1.0 mass %, bleeding out of the additive from the fluororesin composition may occur.

In Embodiment 1, the fluororesin composition contains no conductive particles for imparting electrical conductivity to the resin composition. As described above, this is because low chargeability is realized by the fluororesin composition itself, and a smooth and flat surface of the release layer 13 is provided to thereby attain high gripping performance. Thus, so long as the surface flatness of the release layer 13 is not impaired, the fluororesin composition may contain conductive particles which serve as an additive such as a colorant.

No particular limitation is imposed on the vinylidene fluoride copolymer contained in the fluororesin composition, so long as the release layer 13 formed of the fluororesin composition ensures high releasability, low chargeability, and high friction.

After mixing a fluororesin, a vinylidene fluoride copolymer, and an ionic additive at specific proportions to thereby form the fluororesin composition, the fluororesin composition may be molded to a shape of interest through a known technique such as extrusion, rolling, or injection molding. In Embodiment 1, the composition is molded to a tube, to thereby yield a fluororesin tube. No particular limitation is imposed on the thickness of the fluororesin tube, so long as high releasability, low chargeability, and high friction can be imparted to the tube. The thickness is, for example, 1 μm to 100 μm, preferably 30 μm to 70 μm.

The aforementioned low chargeability of the fluororesin composition can be assessed by measuring the easiness of removing electrostatic charges (surface potential attenuation characteristic). In a specific manner, the target fluororesin composition is molded into a fluororesin tube. The initial potential of the tube, and the potential of the same tube after a specific period of time (i.e., post-relaxation potential) are measured. The ratio of post-relaxation potential to initial potential (percent dielectric relaxation) is calculated, and the chargeability is assessed by the ratio. The percent dielectric relaxation can be calculated by the following formula (1):

Percent dielectric relaxation=1−(post-relaxation potential/initial potential) (1)

The percent dielectric relaxation (%) calculated by formula (1) is 15% or greater, preferably 30% or greater. When the percent dielectric relaxation is smaller than 15%, rapid removal of electric charges of a charged fluororesin composition is impeded. In this case, deposits due to an electric factor increase.

In order to attain high gripping performance, a molded product of the fluororesin composition preferably has a smooth surface. The smoothness of the fluororesin composition is assessed by an index, such as arithmetic average roughness (Ra) as determined in accordance with “JIS B0601 1994.” That is, when the arithmetic average roughness (Ra) falls within a predetermined range, those skilled in the art can determine whether the surface of the fluororesin composition molded product has smoothness. Specifically, the fluororesin composition preferably has an arithmetic average roughness (Ra) of 0.02 μm to 0.07 μm. When the condition is satisfied, there can be attained a sufficient gripping performance for smoothly driving a fixation member such as a fixation belt.

Also, in order to attain high gripping performance, the surface of the fluororesin composition molded product preferably has a characteristic friction coefficient. Friction coefficient may be determined by means of, for example, a commercial measurement apparatus. The friction coefficient is preferably 0.5 or higher, more preferably 0.5 to 10. When the condition is satisfied, there can be attained an enhanced gripping performance for driving a fixation belt. In contrast, when the friction coefficient is lower than 0.5, difficulty is encountered in attaining a gripping performance for smoothly driving a fixation belt.

### Pressure Roller Production Method

Next will be described a method for producing the pressure roller 10. However, the following procedure is given for only an illustrative purpose, and the method is not limited to the following procedure. In Embodiment 1, the pressure roller 10 is produced from liquid-form silicone rubber as a silicone rubber material.

Firstly, a silicone rubber composition is prepared from a liquid-form silicone rubber. Then, a PFA tube (i.e., a fluororesin tube which is formed from a fluororesin composition containing PFA, a vinylidene fluoride copolymer, and an ionic additive) and which serves as the release layer 13 is placed in a metal mold such that the PFA tube is attached to the inner surface of the metal mold in a concentric manner. The core 11 is placed in the metal mold. Notably, the PFA tube is preferably subjected to a treatment for ensuring sufficient adhesion to the below-mentioned silicone rubber. No particular limitation is imposed on the treatment, so long as release of the PFA tube from silicone rubber can be prevented. An example of the treatment is defluorination. In Embodiment 1, the inner surface of the PFA tube has been subjected to defluorination treatment.

Next, the aforementioned silicone rubber composition is charged into a space between the core 11 and the PFA tube release layer 13. The silicone rubber composition is heated, then cooled, and released from the metal mold. More specifically, the released product is heated at a temperature equal to or higher than the curing temperature of the liquid-form silicone rubber, whereby the silicone rubber composition is cured (i.e., primary curing), to thereby yield a silicone rubber. Subsequently, the silicone rubber is further heated (i.e., secondary curing), to thereby form the elastic layer 12. From the viewpoint of ensuring adhesion between the release layer 13 and the elastic layer 12, an optional primer layer may be provided between the release layer 13 and the elastic layer 12.

Through the procedure including the aforementioned steps, the thus-produced pressure roller 10 has the core 11, the elastic layer 12, and the release layer 13, which are sequentially stacked from the inside of the roller. Notably, the thus-obtained pressure roller 10 is formed from a fluororesin composition which ensures high releasability, low chargeability, and high friction.

No particular limitation is imposed on the method of producing the pressure roller 10. In an alternative procedure, the elastic layer 12 is formed on the core 11, and then the elastic layer is optionally polished. Subsequently, the release layer 13 is coated. In this case, the elastic layer 12 may be bound to the release layer 13 by the mediation of a conductive adhesive.

### Embodiment 2

### Fixation Apparatus

Next will be described a fixation apparatus according to Embodiment 2. The fixation apparatus of Embodiment 2 is provided with the pressure roller 10 employed in Embodiment 1 and is employed in an image-forming apparatus. Notably, the same members as employed in Embodiment 1 are denoted by the same reference numbers, and overlapping descriptions therefor are omitted.

FIG. 3 is a schematic cross-section of an example of the structure of the fixation apparatus according to Embodiment 2. As shown in FIG. 3, a fixation apparatus 1 includes the pressure roller 10; a fixation belt 20 disposed opposing the pressure roller 10; a press member 30 which is disposed opposing to the pressure roller 10 and which presses the fixation belt 20 from the inside to the pressure roller 10, to thereby provide a specific nip portion; and heating means 40 for heating the fixation belt 20 to a target temperature. Notably, the heating means 40 may be disposed outside the fixation belt 20.

No particular limitation is imposed on the form of the fixation belt 20, so long as it can provide a specific nip portion via pressing with the pressure roller 10 disposed opposing thereto. For example, the fixation belt 20 includes a metallic substrate having at least one layer of a seamless electrocast belt, an elastic layer formed on the metallic substrate, and a release layer formed on the elastic layer.

The press member 30 is formed of an elastic body (e.g., a rubber body), a resin, a metal, etc. The press member 30 may be coated with an optional layer formed of a fluororesin or the like, coated with a sliding sheet, or grooved. Notably, the surface of the sliding sheet may be roughened.

No particular limitation is imposed on the heating means 40, so long as it can heat the fixation belt 20. The heating means 40 may be disposed outside the fixation belt 20. Examples of the heating means 40 include a halogen heater, a heating wire, an IR heater, and electromagnetic induction heating by, for example, an excitation coil (heat source).

As described above, the fixation apparatus 1 of Embodiment 2 has the pressure roller 10, which ensures high releasability, low chargeability, and high friction. When the fixation apparatus 1 is employed, the pressure roller 10 can smoothly drive the fixation belt 20, to thereby prevent deposition of foreign matter caused by friction charge between the pressure roller 10 and the fixation belt 20. As a result, offset toner or the like can be prevented, and the produced fixation apparatus 1 can exhibit highly reliable image fixability.

### Embodiment 3

### Fixation Apparatus

Next will be described a fixation apparatus according to Embodiment 3. The fixation apparatus of Embodiment 3 is provided with the pressure roller 10 employed in Embodiment 1 and is employed in an image-forming apparatus. The structure thereof differs from that of the fixation apparatus 1 of Embodiment 2. Notably, the same members as employed in Embodiment 2 are denoted by the same reference numbers, and overlapping descriptions therefor are omitted.

FIG. 4 is a schematic cross-section of an example of the structure of the fixation apparatus according to Embodiment 3. As shown in FIG. 4, a fixation apparatus 2 includes the pressure roller 10; a fixation belt 21 disposed opposing the pressure roller 10; an inner roller 50 which presses the fixation belt 21 from the inside to the pressure roller 10; and a heating roller 60 including inside thereof heating means 41. The inner roller 50 and the heating roller 60 are disposed inside the fixation belt 21 (in the space 22). The fixation belt 21 is rotated by means of the inner roller 50 and the heating roller 60. Notably, the pressure roller 10 of Embodiment 3 may be applied to the fixation belt 21 and to the inner roller 50. In one mode of application of the pressure roller 10 to the fixation belt 21, the elastic layer 12 and the release layer 13 formed of a PFA tube may be formed sequentially on a belt substrate formed of a material such as Ni (nickel), Ni/Cu (copper)/Ni, PI (polyimide) resin, or SUS (stainless steel). Notably, the heating means 41 may be disposed outside the heating roller 60.

In the fixation apparatus 2, the fixation belt 21 rotates with the pressure roller 10 in rotation and is heated by means of the heating means 41 disposed inside. The fixation belt 21 is rotated by means of the inner roller 50 and the heating roller 60 which are disposed inside the fixation belt 21 (in the space 22). An unfixed toner image 80 on a recording medium 70 (e.g., a paper sheet) is fixed through heat and pressure during passage of the recording medium 70 between the fixation belt 21 and the pressure roller 10. Further, when the fixation apparatus 2 employs the pressure roller 10, the pressure roller 10 provides sufficient gripping performance for smoothly driving the fixation belt 21, to thereby prevent deposition of foreign matter caused by friction charge between the pressure roller 10 and the fixation belt 21. As a result, offset toner or the like can be prevented, and the produced fixation apparatus 2 can exhibit highly reliable image fixability.

### Embodiment 4

### Fixation Apparatus

Next will be described a fixation apparatus according to Embodiment 4. The fixation apparatus of Embodiment 4 is provided with the pressure roller 10 employed in Embodiment 1 and is employed in an image-forming apparatus. The structure thereof differs from that of the fixation apparatus 1 of Embodiment 2. Notably, the same members as employed in Embodiment 2 are denoted by the same reference numbers, and overlapping descriptions therefor are omitted.

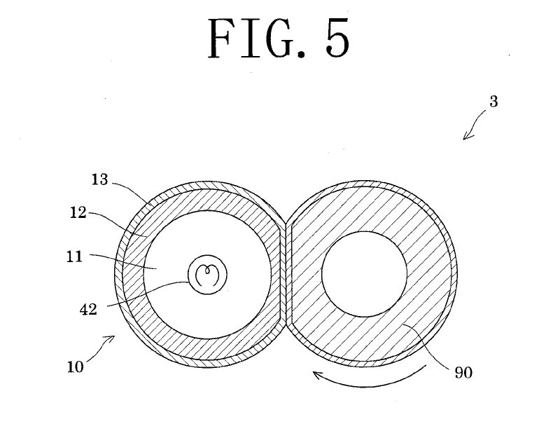

FIG. 5 is a schematic cross-section of an example of the structure of the fixation apparatus according to Embodiment 4. As shown in FIG. 5, a fixation apparatus 3 includes the pressure roller 10 including inside thereof heating means 42; and a fixation roller 90 disposed opposing the pressure roller 10. Notably, the pressure roller 10 of Embodiment 4 may also serve as the fixation roller 90. Also, the heating means 42 may be disposed outside the pressure roller 10.

When the fixation apparatus 3 employs the pressure roller 10, the pressure roller 10 provides sufficient gripping performance for smoothly driving the fixation roller 90, to thereby prevent deposition of foreign matter caused by friction charge between the pressure roller 10 and the fixation roller 90. As a result, offset toner or the like can be prevented, and the produced fixation apparatus 3 can exhibit highly reliable image fixability.

### Modification of Fixation Member

Embodiments of the present invention have been described above. However, the essential components of the present invention are not limited to the aforementioned embodiments. The fixation member according to the present invention can be suitably employed as the aforementioned fixation belt or fixation roller. Also, the fixation member of the invention may be used as, for example, a transfer/fixation belt, which plays a role in fixation immediately after image transfer. Thus, no particular limitation is imposed on the mode of use of the fixation belt. Furthermore, a fixation apparatus employing the fixation member according to the present invention may be employed in variety of image-forming apparatuses (in particular, electrophotographic image-forming apparatuses) such as a copying machine, a facsimile machine, a laser beam printer, a printer of another mode, or a multi-function apparatus thereof.

### EXAMPLES

The present invention will next be described in more detail by way of examples, which should not be construed as limiting the invention thereto.

### Example 1

In Example 1, a pressure roller 10 as shown in FIGS. 1 and 2 was produced by use of a liquid-form silicone rubber. Firstly, an addition-type liquid-form silicone rubber (insulating rubber) (KE-2300-16 A/B, product of Shin-Etsu Chemical Co., Ltd.) was used to prepare a silicone rubber composition.

Then, a low-chargeable PFA tube (film thickness: 30 μm) serving as a release layer 13 was placed over a metal mold (ϕ): 25 μm) such that the PFA tube was attached to the inner surface of the metal mold in a concentric manner. A core 11 (metallic core) was placed in the metal mold having a diameter of 15 mm and made of iron. The outer surface of the core was coated with a primer for liquid-form silicone rubber (DY39-051 A/B, product of Dow Corning Toray), the coating being dried. The used low-chargeable PFA tube contained no conductive particles. The inner surface of the employed low-chargeable PFA tube had been subjected to a defluorination treatment in advance.

Subsequently, the low-chargeable PFA tube inside which a metallic core was placed was placed vertically on a lower flange and fixed with the metallic mold and an upper flange. Separately, a silicone rubber composition was prepared in an injection apparatus and injected to a space between the low-chargeable PFA tube and the metallic core placed in the metal mold, toward a direction from the lower flange to the upper flange. The thus-injected silicone rubber composition was heated at 100° C. to 150° C. for an appropriate period of time, to thereby cure the liquid silicone rubber (primary curing) to form a silicone rubber. As a result, the low-chargeable PFA tube and the metallic core were bonded together.

Then, the assembly was heated in a thermostat tank at 150 to 200° C. for 4 hours, to thereby further cure the silicone rubber (secondary curing) to form an elastic layer 12. The assembly was cooled and released from the metal mold, to thereby yield the pressure roller 10. Table 1 shows materials of the members of the pressure roller 10 of Example 1.

### Example 2

In Example 2, another example in which the pressure roller 10 as shown in FIGS. 1 and 2 was produced by use of an conductive rubber. Specifically, the procedure of Example 1 was repeated, except that the liquid-form silicone rubber of Example 1 was changed to a conductive rubber (X-34-2777 A/B, product of Shin-Etsu Chemical Co., Ltd.), to thereby prepare a conductive rubber composition. Thus, a pressure roller 10 was produced. Table 1 shows materials of the members of the pressure roller 10 of Example 2.

### Comparative Example 1

In Comparative Example 1, another example of the pressure roller 10 as shown in FIGS. 1 and 2 was produced by use of an insulating PFA tube. Specifically, the procedure of Example 1 was repeated, except that the low-chargeable PFA tube of Example 1 serving as the release layer 13 was changed to an insulating PFA tube conductive rubber (451HP-J, product of Du Pont-Mitsui), to thereby produce a pressure roller 10. Notably, the employed insulating PFA tube contained no conductive particles. Table 1 shows materials of the members of the pressure roller 10 of Comparative Example 1. The inner surface of the employed insulating PFA tube had been subjected to a defluorination treatment in advance.

### Comparative Example 2

In Comparative Example 2, another example of the pressure roller 10 as shown in FIGS. 1 and 2 was produced by use of an insulating PFA tube and a conductive rubber. Specifically, the procedure of Example 1 was repeated, except that the liquid-form silicone rubber of Example 1 was changed to a conductive rubber (X-34-2777 A/B, product of Shin-Etsu Chemical Co., Ltd.), to thereby prepare a conductive rubber composition, and that the low-chargeable PFA tube of Example 1 serving as the release layer 13 was changed to an insulating PFA tube (451HP-J, product of Du Pont-Mitsui), to thereby produce a pressure roller 10. Notably, Table 1 shows materials of the members of the pressure roller 10 of Comparative Example 2. The inner surface of the employed insulating PFA tube had been subjected to a defluorination treatment in advance.

### Comparative Example 3

In Comparative Example 3, another example of the pressure roller 10 as shown in FIGS. 1 and 2 was produced by use of a conductive PFA tube. Specifically, the procedure of Example 1 was repeated, except that the low-chargeable PFA tube of Example 1 serving as the release layer 13 was changed to a conductive PFA tube (surface resistivity (nominal): ≤1.0×10⁸ Ω/square, product of Du Pont-Mitsui), to thereby produce a pressure roller 10. Notably, the employed conductive PFA tube contained conductive carbon particles, and the measured sheet resistivity of the conductive PFA tube was 2.13×10⁷ Ω/square. Table 1 shows materials of the members of the pressure roller 10 of Comparative Example 3. The inner surface of the employed insulating PFA tube had been subjected to a defluorination treatment in advance.

### Test Example 1

### Measurement of Critical Surface Tension

The critical surface tension of each of the PFA tubes employed in Examples 1 and 2 and Comparative Examples 1 to 3 was measured by means of a contact angle goniometer (Drop Master, product of Kyowa Interface Science Co., Ltd.). In a specific procedure, critical surface tension was calculated by Zisman's Plot. In measuring contact angle, liquid mixtures for wet surface tension test (product of Wako Pure Chemical Industries, Ltd., No. 40, No. 35, No. 30, No. 27.3, and No. 22.6) were used. The measurement was conducted at 23° C. and 150° C. Table 2 shows the obtained measurements.

### Test Example 2

### Evaluation of Surface Potential Attenuation Characteristics

The percent dielectric relaxation of each of the PFA tubes and pressure rollers 10 employed in Examples 1 and 2 and Comparative Examples 1 to 3 was measured by means of a dielectric relaxation measuring apparatus. In a specific procedure, a charge voltage of 3 kV was applied between an electrode and the surface of the PFA tube or the pressure roller 10, to thereby cause arc discharge. Then, the electric potential of the surface of the PFA tube or the pressure roller 10 was measured 0.08 seconds after (initial) and 50 seconds after (post-relaxation) the application of charge voltage. Also, the difference between the initial potential and the post-relaxation potential (i.e., relaxation potential) was calculated, and the ratio of post-relaxation potential to initial potential (percent dielectric relaxation (%)) was derived. Tables 1 and 2 show the measured and calculated values. Notably, the percent dielectric relaxation was calculated by the following formula (2):

Percent dielectric relaxation=1−(post-relaxation potential/initial potential) (2)

### Test Example 3

### Surface Resistivity Measurement

The surface resistivity of each of the PFA tubes and pressure rollers 10 employed in Examples 1 and 2 and Comparative Examples 1 to 3 was measured by means of a resistivity meter (Hiresta UP, MCP-HT450, product of Mitsubishi Chemical Analytech Co., Ltd.) and a probe (UR-100, MCP-HTP16, product of Mitsubishi Chemical Analytech Co., Ltd.). In a specific procedure, a voltage (10 V, 100 V, 250 V, and 1000 V) was applied to the surface layer of a torn piece of each PFA tube and each pressure roller 10, and resistivity was measured for 10 seconds. Tables 1 and 2 show the resistivity measurements.

### Test Example 4

### Surface Roughness Measurement

The arithmetic average surface roughness (Ra) μm (in the axial direction) of each of the pressure rollers 10 produced in Examples 1 and 2 and Comparative Examples 1 to 3 was measured by means of a surface texture measuring instrument (Surfcom 1400D, product of Tokyo Seimitsu Co., Ltd.) in accordance with a measurement method disclosed in “JIS B0601 1994.” The measurement was conducted at a measurement path of 2.5 mm and a cut-off of 0.8 mm. Table 1 shows the measurements.

### Test Example 5

### Friction Coefficient Measurement

The friction coefficient of each of the PFA tubes employed in Examples 1 and 2 and Comparative Examples 1 to 3 was measured by means of a friction coefficient measuring apparatus (Heidon-14DR). The friction coefficient was measured between the surface of the insulating PFA tube and a counter sliding member. In a specific procedure, the measurement was conducted by use of an indenter plate at a load of 500 gf and sliding speed of 50 mm/minute and at room temperature (25° C.) and 150° C. Table 2 shows the measurements.

### Test Example 6

### Properties of Roller: Off-Set Property

The toner fixation state of each of the pressure rollers 10 produced in Examples 1 and 2 and Comparative Examples 1 to 3 was observed by means of a commercial color printer. In a specific procedure, a solid print image (color: black) provided by the color printer was placed on a hot plate, and the pressure roller 10 was caused to press against the solid image for 10 minutes. The roller was removed from the image, and transfer of the toner to the image contact area of the roller surface was observed. During the observation, the temperature of the hot plate was elevated from 100° C. to 170° C. in increments of 10 degrees. The results of the observation is shown in Table 1. The off-set state was assessed with the following ratings: deposition of an area of toner (“X”); deposition of lines of toner (“A”); and no toner deposition (“0”). Notably, the temperature 170° C. is the melting temperature of the toner employed in the color printer.

### Test Example 7

### Properties of Roller: Anti-Slip Property

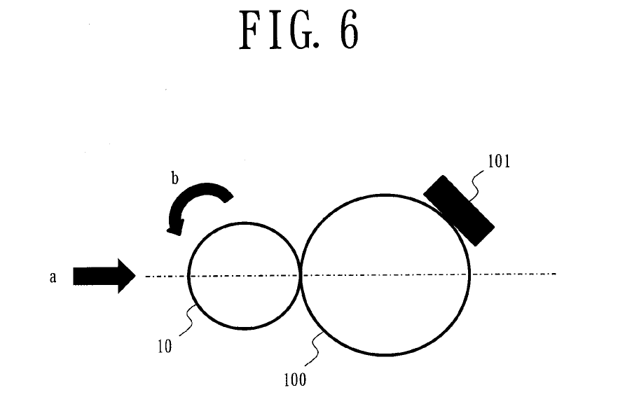

FIG. 6 is a sketch showing the test method employed in Test Example 7. Each of the pressure rollers 10 produced in Examples 1 and 2 and Comparative Examples 1 to 3, and a counter roller 100 were placed as shown in FIG. 6. Then, the upper limit of the torque which allows the counter roller 100 to rotate was measured. To the counter roller 100, a rotation stopper (a brake 101) was attached. In a specific procedure, the counter roller 100 was rotated with the pressure roller 10, and the torque which allowed the counter roller 100 to overcome the resistance of the brake 101 and to rotate without slipping was measured. During the measurement, the total press load toward the direction a (arrow a in FIG. 6) was adjusted to 200 N, 300 N, 400 N, and 500 N. The driving torque when the pressure roller 10 was rotated toward the direction b (arrow b in FIG. 6) was measured at the shaft of the pressure roller 10. The measurement was conducted at room temperature (25° C.). The measurements are shown in Table 1.

TABLE 1

| | | | | Ex. 1 | Ex. 2 | Comp. 1 | Comp. 2 | Comp. 3 |
|---|---|---|---|---|---|---|---|---|
| Pressure roller | | Release layer | | LC PFA | LC PFA | Ins. PFA | Ins. PFA | Cond. PFA |
| | | Elastic layer | | Ins. rubber | Cond. rubber | Ins. rubber | Cond. rubber | Ins. rubber |
| Surface potential | | Initial (V) | | 565 | 291 | 578 | 288 | −5 |
| attenuation | | Post relax. (V) | | 288 | 201 | 509 | 277 | −6 |
| | | Relax (V) | | 277 | 90 | 69 | 12 | 1 |
| | | % Relax (%) | | 49 | 31 | 12 | 4 | −12 |
| Surface resistivity | | 10 | V | Over range | Over range | Over range | Over range | 2.85 × 10⁷ |
| (Ω/square) | | 100 | V | Over range | Over range | Over range | Over range | Under range |
| | | 250 | V | Over range | Over range | Over range | Over range | Under range |
| | | 1000 | V | Over range | Over range | Over range | Over range | Under range |
| Arith. av. roughness Ra (μm) | | | | 0.05 | 0.05 | 0.04 | 0.04 | 0.10 |
| Roller | Off-set | 100° | C. | ◯ | ◯ | ◯ | ◯ | ◯ |
| properties | | 110° | C. | ◯ | ◯ | ◯ | ◯ | ◯ |
| | | 120° | C. | ◯ | ◯ | ◯ | ◯ | ◯ |
| | | 130° | C. | ◯ | ◯ | ◯ | ◯ | ◯ |
| | | 140° | C. | ◯ | ◯ | ◯ | ◯ | ◯ |
| | | 150° | C. | Δ | Δ | X | X | Δ |
| | | 160° | C. | Δ | Δ | X | X | X |
| | | 170° | C. | X | X | X | X | X |

| | | | | | | |
|---|---|---|---|---|---|---|
| Anti-slip | 200N | 0.7 | 0.7 | 0.6 | 0.6 | 0.5 |
| | 300N | 1.1 | 1.1 | 1.1 | 1.1 | 0.7 |
| | 400N | 1.5 | 1.5 | 1.5 | 1.5 | 0.9 |
| | 500N | 1.9 | 1.9 | 1.8 | 1.8 | 1.3 |

LC: low-chargeable

TABLE 2

| | | | LC PFA | Ins. PFA | Cond |
|---|---|---|---|---|---|
| | | | tube | tube | PFA tube |
| Critical surface tension (°) | | | 17 | 17 | 14 |
| Surface | Initial (V) | | 222 | 250 | −5 |
| potential | Post relax. (V) | | 145 | 240 | −5 |
| attenuation | Relax (V) | | 77 | 10 | 0 |
| | % Relax (%) | | 35 | 4 | −7 |
| Surface | 10 | V | Over range | Over range | 2.13 × 10⁷ |
| resistivity | 100 | V | Over range | Over range | Under range |
| (Ω/square) | 250 | V | Over range | Over range | Under range |
| | 1000 | V | Over range | Over range | Under range |

| | | | | |
|---|---|---|---|---|
| Friction | room temp. | 0.6 | 0.9 | 0.3 |
| coeff. | (25° C.) | | | |
| | 150° C. | 7.2 | 8.5 | 1.1 |

LC: low-chargeable

### Results

As shown in Tables 1 and 2, the pressure rollers 10 of Examples 1 and 2, containing no conductive particles and employing a low-chargeable PFA tube containing a fluororesin, a vinylidene fluoride copolymer, and an ionic additive, exhibited excellent electrical insulating property and low chargeability. Even when charged, these pressure rollers could be immediately discharged. In addition, these pressure rollers 10 were found to have a flat surface.

As also shown in FIG. 1, the pressure rollers 10 of Examples 1 and 2 were found to cause no toner off-set even at high temperature (Test Example 6), and to exhibit reduced slipping and enhanced gripping performance (Test Example 7). Thus, the pressure rollers 10 of Examples 1 and 2 were found to ensure high releasability, low chargeability, and high friction.

In contrast, as shown in Tables 1 and 2, the pressure rollers 10 of Comparative Examples 1 and 2, employing an insulating PFA tube, virtually could not be discharged, when charged. In Test Example 6, difficulty was encountered in preventing toner off-set in a high-temperature range (≥150° C.)

Meanwhile, as shown in Tables 1 and 2, the pressure roller 10 of Comparative Example 3, employing a conductive PFA tube containing conductive particles, was found to have a rough surface. Thus, charging was virtually prevented. In addition, as shown in Table 1, difficulty was encountered in preventing toner off-set in a high-temperature range (160° C.) (Test Example 6), and the slip reduction effect was smaller than that of the pressure rollers 10 of Examples 1 and 2 (Test Example 7).

The fixation member of the present invention is particularly suitable for use in a fixation unit of an image-forming device, such as an electrophotographic printer or copying machine.

What is claimed is:

1. A fixation member having an elastic layer, and a release layer on the external surface of the elastic layer, wherein the release layer is formed of a fluororesin tube having low chargeability and a percent dielectric relaxation of 15% or higher.

2. A fixation member according to claim 1, wherein the release layer has an arithmetic average roughness (Ra) of 0.02 μm to 0.07 μm.

3. A fixation member according to claim 1, wherein the release layer has a friction coefficient of 0.5 or higher.

4. A fixation member according to claim 2, wherein the release layer has a friction coefficient of 0.5 or higher.
